(19) United States
(12) Patent Application Publication
(10) Pub. No.: US 2014/0207743 A1
(43) Pub. Date: Jul. 24, 2014

(54) Method for Storage Driven De-Duplication of Server Memory

(71) Applicant: LSI CORPORATION, San Jose, CA (US)

(72) Inventor: Robert F. Quinn, Campbell, CA (US)

(73) Assignee: LSI Corporation, San Jose, CA (US)

(21) Appl. No.: 13/755,998

(22) Filed: Jan. 31, 2013

Related U.S. Application Data
(60) Provisional application No. 61/754,146, filed on Jan. 18, 2013.

(51) Int. Cl. G06F 17/30

(52) U.S. Cl. CPC G06F 17/30283
USPC 707/692

(57) ABSTRACT

A method for storage driven de-duplication of server memory comprises configuring a storage controller, as part of each IO operation, to generate a unique signature for each data page passing through the controller. The method associates the signature with the data page and stores the associated page and signature. The signature is added to a signature queue for signature match analysis with signatures stored in server memory. Signature analysis is limited to read-only pages to speed up analysis of pages more likely to be duplicates. Once a duplicate page is found, a page table is updated to point to the match page and the duplicate page is added to a free list.

The present application claims priority under 35 U.S.C. §119(e) of U.S. Provisional Application Ser. No. 61/754,146 filed Jan. 18, 2013 entitled “Method for Storage Driven De-Duplication of Server Memory” by Quinn, which is incorporated by reference herein in its entirety.

### TECHNICAL FIELD

The present disclosure relates generally to the field of storage management of storage semiconductors Et protocols (e.g. ROCs, SAS, SATA, expanders, FC, PCIe). More particularly, embodiments of the present invention relate to storage-driven removal of a duplicate data page from a memory.

### BACKGROUND

Finite server memory capacity may require an operator to increase system capabilities which are designed to most efficiently use the capacity. Server memory may reach storage capacity limits with ever increasing file/application size. De-duplication is emerging as a method to minimize server memory requirements by eliminating replication of identical data pages of memory.

Scanning memory and generating a signature is an expensive and processor-burdensome operation. Signature generation and comparison can use CPU cycles, require memory bandwidth, and pollute processor caches with data that may not otherwise have been cached through the normal mechanisms of temporal or spatial locality.

With existing solutions creating heavy burdens on OS and Processor time, a solution to offload the identification of duplicate memory pages from the OS and Processor may be of specific value.

Therefore, it would be advantageous if a method and system existed providing for storage driven generation of memory page signatures, along with the identification of potential duplicate pages, and offloading the main system processors from these computationally expensive data-path tasks, while allowing the main system processors to continue to manage the OS page tables and collapse the duplicate pages to a single physical page.

### SUMMARY

In one embodiment, a method for de-duplication of system memory may comprise configuring a storage controller, as part of every read input operation, to accomplish the steps of receiving a first data page, generating a first signature for the first data page, the first signature having an associated first page table entry, associating the first signature with the first data page, storing the first associated signature in a signature queue and in a server memory, receiving a second data page, generating a second signature for the second data page, the second signature having an associated second page table entry, associating the second signature with the second data page, storing the second associated signature in the signature queue, configuring an Operating System (OS) module to read the first associated signature and the second associated signature, comparing the second associated signature stored in the signature queue with the first associated signature stored in the server memory, determining if a signature match is positive as a result of the comparing, replacing the second page table entry with the first page table entry in a page table if the signature match is positive, and placing the second page table entry on a free page list maintained by the OS module if the signature match is positive.

In an embodiment, a computer readable medium within a storage controller is disclosed storing non-transitory computer readable program code embodied therein for de-duplication of a physical memory page, the computer readable program code comprising instructions which, when executed by a storage controller processor as part of each read input operation, perform and direct the steps of receiving a first data page, generating a first signature for the first data page, the first signature having an associated first page table entry, associating the first signature with the first data page, storing the first associated signature in a signature queue and in a server memory, receiving a second data page, generating a second signature for the second data page, the second signature having an associated second page table entry, associating the second signature with the second data page, storing the second associated signature in the signature queue, configuring an Operating System (OS) module to read the first associated signature and the second associated signature, comparing the second associated signature stored in the signature queue with the first associated signature stored in the server memory, determining if a signature match is positive as a result of the comparing, replacing the second page table entry with the first page table entry in a page table if the signature match is positive, and placing the second page table entry on a free page list maintained by the OS module if the signature match is positive.

Additional embodiments of the present invention include an in-line operation accomplished by the storage controller and attaching a digital signature to the data page, creating an additional data file containing a variable mapped to each one of the data page, and combining the data page with the signature to create a third page.

Additional embodiments of the present invention include configuring a hypervisor to read the first associated signature and the second associated signature, configuring the signature queue in an order, and a comparison before the read input operation is complete.

Additional embodiments of the present invention include a method where the first signature and the second signature are generated during a write output, the generated signatures are stored within data associated with the write output and a separate structure.

Additional embodiments of the present invention include comparing the generated signatures prior to a data read operation and analysis of a data page title, a data page size, a data page creation date, a data page modification date, a data page author, and a data page text.

Additional embodiments of the present invention include a reordering of the page table to reflect the signature match and a configuration for discontinuing the read input operation before the read input operation is complete.

Additional embodiments of the present invention include configuring the data page for availability to an additional operation and storing the second associated signature in the server memory if the signature match is negative.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a view of a preferred embodiment of the logic path found in the present invention; and

FIG. 2 is block diagram illustrating an implementation of the method for storage driven de-duplication of server memory representative of a preferred embodiment of the present invention.

### DETAILED DESCRIPTION

Reference will now be made in detail to the subject matter disclosed, which is illustrated in the accompanying drawings.

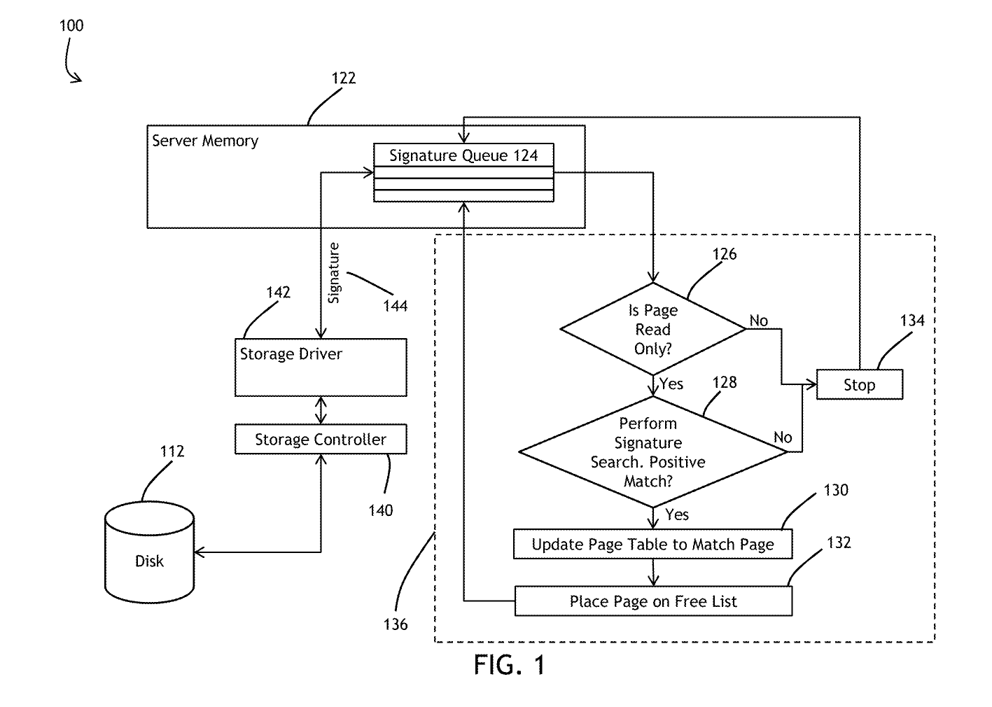

Referring to FIG. 1, a flow diagram illustrating a view of a preferred embodiment of the logic path found in the present invention is shown. Disk 112 may operate in well-known manner executing data input and output operations with server memory 122. To facilitate the input output operations storage controller 140 and storage driver 142 may control disk 112 interaction with server memory 122.

As a function of a preferred embodiment of the present invention, storage controller 140 may generate a signature 144 unique to each data page passing through the controller 140. Although the generated signature may be unique to each data page, it will be an exact match for each duplicate data page passing through the controller. Storage controller 140 may further associate each generated signature 144 with the server memory page where the data was delivered and may store the address of that memory page in the signature queue 124 along with the signature 144. Storage driver 142 may transmit the signature to signature queue 124 which may reside in server memory 122. Signature queue 124 may function as a queue of signatures awaiting analysis.

Signature generation may occur each time a read input operation is commanded and a data page passes through the storage controller 140. For each read input operation, storage controller 140 may command generation of a signature 144 for each page of the read input operation.

Preferably, de-duplication may not be attempted for modified pages, or if de-duplication is to be attempted for modified pages then the pages may be set to read only and the signatures regenerated and compared. An additional goal of the current invention includes elimination of modified pages (pages which are not read only) from signature analysis to speed up the remaining de-duplication operation. In practice, once a data page has been modified (not read only) by an application, the possibility that a duplicate data page exists decreases dramatically. At step 126 the method may determine if the data page associated with the signature 144 is read only. If the data page is found to be read only (un-modified), the method continues analysis with logic passing to step 128. Should the method find the page not read only, the method may stop 134 operation concerning de-duplication and return to read the next signature in the signature queue 124.

Alternatively, analysis 126 of pages found not to be read only falls within contemplation of the current invention.

Step 128 makes an analysis between signatures read from the signature queue 124 and signatures stored in server memory 122. Should the analysis find no matching signature in the server memory, logic may stop 134 operation and return to read the next signature in the queue 124. During this step, additional actions including storing the second signature in the server memory can make the second signature available for future searches. Should the analysis find a matching signature, logic may continue analysis to step 130.

Step 130 updates the page table to direct all references to the memory page written by the storage controller to reference the match page. The match page as used herein may be defined as the page in server memory 122 with an associated signature 144 matching the signature read from the signature queue 124. As the method 136 may find these match pages, it may update each associated entry in the page table to point to the one physical page for which the method has previously stored. Logic then passes to step 132 to place the duplicate page (the duplicate of the match page) on a free list of unallocated memory pages.

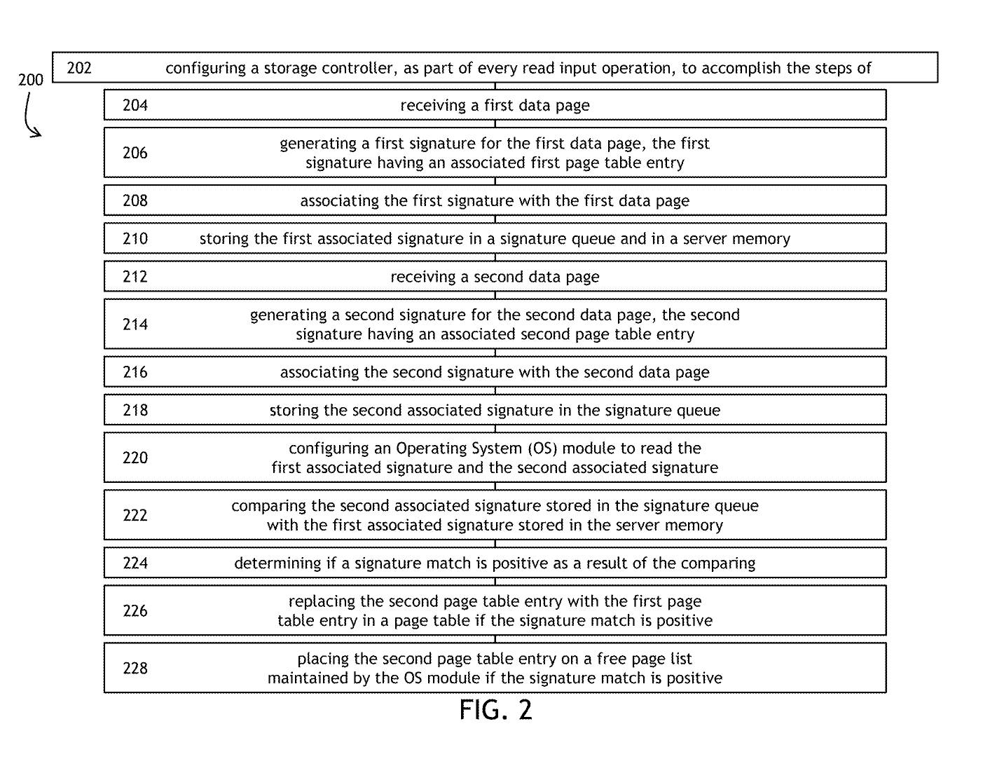

Referring to FIG. 2, a block diagram illustrating an implementation of the method 200 for storage driven de-duplication of server memory representative of a preferred embodiment of the present invention is shown. Step 202 configures a storage controller, as part of every read input operation, to accomplish the steps of receiving a first data page at step 204, generating a first signature for the first data page, the first signature having an associated first page table entry at step 206, associating the first signature with the first data page at step 208, and storing the first associated signature in a signature queue and in a server memory at step 210. Method 200 continues at step 212 with receiving a second data page, and, at step 214, generating a second signature for the second data page, the second signature having an associated second page table entry, and at step 216, associating the second signature with the second data page, and at step 218, storing the second associated signature in the signature queue, and at step 220, configuring an Operating System (OS) module to read the first associated signature and the second associated signature. Method 200 continues at step 222, with comparing the second associated signature stored in the signature queue with the first associated signature stored in the server memory, determining if a signature match is positive as a result of the comparison at step 224, replacing the second page table entry with the first page table entry on a page table if the signature match is positive at step 226, and placing the second page table entry on a free page list maintained by the OS module if the signature match is positive at step 228.

It should be recognized that while the above description describes the concept of server driven de-duplication of server memory, the above description does not represent a limitation but merely an illustration.

In the present disclosure, the methods disclosed may be implemented as sets of instructions or software readable by a device. Such software may a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for de-duplication of a data page, comprising:
configuring a storage controller, as part of every read input operation, to accomplish the steps of:
receiving a first data page;
generating a first signature for said first data page, said first signature having an associated first page table entry;
associating said first signature with said first data page;
storing said first associated signature in a signature queue and in a server memory;
receiving a second data page;
generating a second signature for said second data page, said second signature having an associated second page table entry;
associating said second signature with said second data page;
storing said second associated signature in said signature queue;
configuring an Operating System (OS) module to read said first associated signature and said second associated signature;
comparing said second associated signature stored in said signature queue with said first associated signature stored in said server memory;
determining if a signature match is positive as a result of said comparing;
replacing said second page table entry with said first page table entry in a page table if said signature match is positive; and
placing said second page table entry on a free page list maintained by said OS module if said signature match is positive.

2. The method of claim 1, wherein said generating a first signature for said first data page further comprises an in-line operation accomplished by said storage controller.

3. The method of claim 1, wherein said associating said first signature with said first data page further comprises at least one of: attaching a digital signature to said data page, creating an additional data file containing a variable mapped to each one of said data page, and combining said data page with said signature to create a third page.

4. The method of claim 1, wherein said configuring an Operating System (OS) module to read said first associated signature and said second associated signature further comprises configuring a hypervisor to read said first associated signature and said second associated signature.

5. The method of claim 1, wherein said storing said first associated signature in a signature queue in a server memory further comprises configuring said signature queue in an order.

6. The method of claim 1, wherein said comparing said second associated signature stored in said signature queue with said first associated signature stored in said server memory further comprises a comparison before said read input operation is complete.

7. The method of claim 1, wherein said first signature and said second signature are generated during a write output, said generated signatures are stored within at least one of: data associated with said write output and a separate structure.

8. The method of claim 1, wherein during said read input operation, said generated signatures are compared prior to a data read operation.

9. The method of claim 1, wherein said comparing said second associated signature stored in said signature queue with said first associated signature stored in said server memory further comprises an analysis of at least one of: a data page title, a data page size, a data page creation date, a data page modification date, a data page author, and a data page text.

10. The method of claim 1, wherein said replacing said second page table entry with said first page table entry if said signature match is positive further comprises a reordering of said page table to reflect said signature match.

11. The method of claim 1, wherein said placing said second page table entry on a free page list further comprises discontinuing said read input operation before said read input operation is complete.

12. The method of claim 1, wherein said placing said second page table entry on a free page list further comprises configuring said data page for availability to an additional operation.

13. The method of claim 1, wherein said placing said second page table entry on a free page list further comprises storing said second associated signature in said server memory if said signature match is negative.

14. A computer readable medium within a storage controller storing non-transitory computer readable program code embodied therein for de-duplication of a physical memory page, the computer readable program code comprising instructions which, when executed by a storage controller processor as part of every read input operation, perform and direct the steps of:
receiving a first data page;
generating a first signature for said first data page, said first signature having an associated first page table entry;
associating said first signature with said first data page;
storing said first associated signature in a signature queue and in a server memory;
receiving a second data page;
generating a second signature for said second data page, said second signature having an associated second page table entry;
associating said second signature with said second data page;
storing said second associated signature in said signature queue;
configuring an Operating System (OS) module to read said first associated signature and said second associated signature;
comparing said second associated signature stored in said signature queue with said first associated signature stored in said server memory;
determining if a signature match is positive as a result of said comparing;
replacing said second page table entry with said first page table entry in a page table if said signature match is positive; and
placing said second page table entry on a free page list maintained by said OS module if said signature match is positive.

15. The computer readable medium of claim 14, wherein said generating a first signature for said first data page further comprises an in-line operation accomplished by said storage controller processor.

16. The computer readable medium of claim 14, wherein said associating said first signature with said first data page further comprises at least one of: attaching a digital signature to said data page, creating an additional data file containing a variable mapped to each one of said data page, and combining said data page with said signature to create a third page.

17. The computer readable medium of claim 14, wherein said configuring an Operating System (OS) module to read said first associated signature and said second associated signature further comprises configuring a hypervisor to read said first associated signature and said second associated signature.

18. The computer readable medium of claim 14, wherein said storing said first associated signature in a signature queue in a server memory further comprises configuring said signature queue in an order.

19. The computer readable medium of claim 14, wherein said comparing said second associated signature stored in said signature queue with said first associated signature stored in said server memory further comprises a comparison before said read input operation is complete.

20. The computer readable medium of claim 14, wherein said first signature and said second signature are generated during a write output, said generated signatures are stored within at least one of: data associated with said write output and a separate structure.

21. The computer readable medium of claim 14, wherein during said read input operation, said generated signatures are compared prior to a data read operation.

22. The computer readable medium of claim 14, wherein said comparing said second associated signature stored in said signature queue with said first associated signature stored in said server memory further comprises an analysis of at least one of: a data page title, a data page size, a data page creation date, a data page modification date, a data page author, and a data page text.

23. The computer readable medium of claim 14, wherein said replacing said second page table entry with said first page table entry if said signature match is positive further comprises a reordering of said page table to reflect said signature match.

24. The computer readable medium of claim 14, wherein said placing said second page table entry on a free page list further comprises discontinuing said read input operation before said read input operation is complete.

25. The computer readable medium of claim 14, wherein said placing said second page table entry on a free page list further comprises configuring said data page for availability to an additional operation.

26. The computer readable medium of claim 14, further comprising storing said second associated signature in said server memory if said signature match is negative.
